(19) United States
(12) Patent Application Publication
(10) Pub. No.: US 2024/0324642 A1
(43) Pub. Date: Oct. 3, 2024

(54) HEALTHY SWEETENER

(71) Applicant: Sugar License LLC, Newton, MA (US)

(72) Inventor: Ross Anapolle, Newton, MA (US)

(73) Assignee: Sugar License LLC, Newton, MA (US)

(21) Appl. No.: 18/617,463

(22) Filed: Mar. 26, 2024

Related U.S. Application Data
(60) Provisional application No. 63/454,906, filed on Mar. 27, 2023.
(60) Provisional application No. 63/535,550, filed on Aug. 30, 2023.
(60) Provisional application No. 63/539,559, filed on Sep. 20, 2023.
(60) Provisional application No. 63/598,528, filed on Nov. 13, 2023.

(51) Int. Cl. A23L 27/30; A23L 2/60; A23L 29/30

(52) U.S. Cl. CPC A23L 27/34; A23L 2/60; A23L 29/37

(57) ABSTRACT

Food and/or beverage additives are generally provided. In some embodiments, the additive comprises a sweetener (e.g., a healthy sweetener). The additives and/or sweeteners described herein may be useful when added a food and/or beverage e.g., to increase the sweetness of a food and/or beverage. In some embodiments, the additives and/or sweeteners may advantageously be used to reduce the sugar and/or caloric content of a food and/or beverage e.g., as compared to the food and/or beverage without the additive and/or sweetener or containing conventional sweeteners. Advantageously, the additives comprising the sweeteners described herein may be useful for providing a food and/or beverage having a relatively low glycemic index and/or a relatively low number of calories per serving.

### FIELD

The present inventive concepts generally relate to the field of additives comprising sweeteners, in particular, the present invention generally relates to healthy sweeteners for use in food and beverages.

### SUMMARY

The subject matter of the present disclosure involves, in some cases, interrelated products, alternative solutions to a particular problem, and/or a plurality of different uses of one or more systems and/or articles.

Aspects of the present disclosure generally relate to additives comprising healthy sweeteners (e.g., for use in food and/or beverages).

In one aspect, food and/or beverage additives are provided. In some embodiments, the additive comprises a sweetener comprising fructose present in an amount greater than or equal to 20 wt % and less than or equal to 60 wt % versus the total weight of the sweetener, glucose present in an amount greater than or equal to 5 wt % and less than or equal to 35 wt % versus the total weight of the sweetener, sorbitol present in an amount greater than or equal to 0.5 wt % and less than or equal to 10 wt % versus the total weight of the sweetener, and sucrose present in an amount greater than or equal to 0 wt % and less than or equal to 20 wt %, wherein the sweetener has one or more of the following properties: i) a Brix of greater than or equal to 70 and less than or equal to 80; ii) a glycemic index of less than or equal to 55 as measured according to ISO 26642:2010; and/or iii) a number of calories of less than or equal to 20 kilocalories per 4 grams of sweetener as measured using a bomb calorimeter.

In some embodiments, the additive comprises an apple-derived sweetener comprising a mixture of fructose, glucose, sorbitol, and sucrose, wherein the sweetener has a Brix of greater than or equal to 70 and less than or equal to 80 and a glycemic index of less than or equal to 55 as measured according to ISO 26642:2010.

In another aspect, edible consumer products are provided. In some embodiments, the edible consumer product comprises a food product and a coating and/or powder, the coating and/or powder comprising a sweetener, the sweetener comprising: fructose present in an amount greater than or equal to 20 wt % and less than or equal to 60 wt % versus the total weight of the sweetener, glucose present in an amount greater than or equal to 5 wt % and less than or equal to 35 wt % versus the total weight of the sweetener, sorbitol present in an amount greater than or equal to 0.5 wt % and less than or equal to 10 wt % versus the total weight of the sweetener, and sucrose present in an amount greater than or equal to 0 wt % and less than or equal to 20 wt %.

In some embodiments, the edible consumer product comprises a beverage and an additive comprising a sweetener, the sweetener comprising fructose present in an amount greater than or equal to 20 wt % and less than or equal to 60 wt % versus the total weight of the sweetener, glucose present in an amount greater than or equal to 5 wt % and less than or equal to 35 wt % versus the total weight of the sweetener, sorbitol present in an amount greater than or equal to 0.5 wt % and less than or equal to 10 wt % versus the total weight of the sweetener, and sucrose present in an amount greater than or equal to 0 wt % and less than or equal to 20 wt %.

Other advantages and novel features of the present disclosure will become apparent from the following detailed description of various non-limiting embodiments of the disclosure when considered in conjunction with the accompanying figures.

### BRIEF DESCRIPTION OF THE DRAWINGS

Non-limiting embodiments of the present disclosure will be described by way of example with reference to the accompanying figures, which are schematic and are not intended to be drawn to scale unless otherwise indicated. In the figures, each identical or nearly identical component illustrated is typically represented by a single numeral. For purposes of clarity, not every component is labeled in every figure, nor is every component of each embodiment of the disclosure shown where illustration is not necessary to allow those of ordinary skill in the art to understand the disclosure. In the figures:

FIGS. 1A and 1B are schematic diagrams of edible consumer products and additives, according to one set of embodiments; and

FIG. 2 is a plot of the blood glucose level of subjects after consuming an additive as described herein or a control sample as a function of time, according to one set of embodiments.

### DETAILED DESCRIPTION

Aspects of the present disclosure generally relate to additives comprising healthy sweeteners (e.g., for use in food and/or beverages). The present inventive concept may, however, be embodied in many different forms and should not be construed as limited to the exemplary embodiments set forth herein.

Food and/or beverage additives are generally provided. In some embodiments, the additive comprises a sweetener (e.g., a healthy sweetener). The additives and/or sweeteners described herein may be useful when added a food and/or beverage e.g., to increase the sweetness of a food and/or beverage. In some embodiments, the additives and/or sweeteners may advantageously be used to reduce the sugar and/or caloric content of a food and/or beverage e.g., as compared to the food and/or beverage without the additive and/or sweetener or containing conventional sweeteners. Advantageously, the additives comprising the sweeteners described herein may be useful for providing a food and/or beverage having a relatively low glycemic index and/or a relatively low number of calories per serving.

Advantageously, beverages (e.g., juice concentrates) and/or foods comprising the additives and/or sweeteners described herein may have lower amounts of fructose as compared to the amount of fructose typically present in such beverages/foods, e.g., containing conventional sweeteners. Without wishing to be bound by theory, by lowering the amount of fructose in a beverage (or food) (e.g., effectively increasing the ratio of other sugars present in the beverage/food, such as glucose), a relatively low glycemic index may be obtained. As recognized by the inventors, lower levels of fructose may provide benefits to a consumer. The term “consumer,” as used herein, refers to an individual organism such as a human or an animal. In some embodiments, the consumer is a mammal (e.g., a human, a non-human primate, or a non-human mammal), a vertebrate, a laboratory animal, a domesticated animal, an agricultural animal, or a companion animal. In some embodiments, the consumer is a human. In some embodiments, the consumer is a rodent, a mouse, a rat, a hamster, a rabbit, a dog, a cat, a cow, a goat, a sheep, or a pig.

As generally described herein, the additive generally comprises a sweetener. In some embodiments, the sweetener comprises a combination of two or more of fructose, glucose, sorbitol and, optionally, sucrose, or derivatives thereof.

In some embodiments, fructose is present in the sweetener in an amount greater than or equal to 20 wt %, greater than or equal to 25 wt %, greater than or equal to 26.9 wt %, greater than or equal to 30 wt %, greater than or equal to 35 wt %, greater than or equal to 40 wt %, greater than or equal to 45 wt %, greater than or equal to 50 wt %, greater than or equal to 53.6 wt %, or greater than or equal to 55 wt % versus the total weight of the sweetener. In some embodiments, fructose is present in the sweetener in an amount less than or equal to 60 wt %, less than or equal to 55 wt %, less than or equal to 53.6 wt %, less than or equal to 50 wt %, less than or equal to 45 wt %, less than or equal to 40 wt %, less than or equal to 35 wt %, less than or equal to 30 wt %, less than or equal to 26.9 wt %, or less than or equal to 25 wt % versus the total weight of the sweetener. Combinations of the above-referenced ranges are also possible (e.g., greater than or equal to 20 wt % and less than or equal to 60 wt %). Other ranges are also possible. In an exemplary set of embodiments, fructose is present in the sweetener in an amount greater than or equal to 26.9 wt % and less than or equal to 53.6 wt %.

In some embodiments, glucose is present in the sweetener in an amount greater than or equal to 5 wt %, greater than or equal to 9 wt %, greater than or equal to 10 wt %, greater than or equal to 15 wt %, greater than or equal to 20 wt %, greater than or equal to 25 wt %, greater than or equal to 30 wt %, or greater than or equal to 30.6 wt % versus the total weight of the sweetener. In some embodiments, glucose is present in the sweetener in an amount less than or equal to 35 wt %, less than or equal to 30.6 wt %, less than or equal to 30 wt %, less than or equal to 25 wt %, less than or equal to 20 wt %, less than or equal to 15 wt %, less than or equal to 10 wt %, or less than or equal to 9 wt % versus the total weight of the sweetener. Combinations of the above-referenced ranges are also possible (e.g., greater than or equal to 5 wt % and less than or equal to 35 wt %). Other ranges are also possible. In an exemplary set of embodiments, glucose is present in the sweetener in an amount greater than or equal to 9 wt % and less than or equal to 30.6 wt %.

In some embodiments, sorbitol is present in the sweetener in an amount greater than or equal to 0.5 wt %, greater than or equal to 1 wt %, greater than or equal to 1.2 wt %, greater than or equal to 2 wt %, greater than or equal to 4 wt %, greater than or equal to 5 wt %, greater than or equal to 5.4 wt %, greater than or equal to 6 wt %, or greater than or equal to 8 wt % versus the total weight of the sweetener. In some embodiments, sorbitol is present in the sweetener in an amount less than or equal to 10 wt %, less than or equal to 8 wt %, less than or equal to 6 wt %, less than or equal to 5.4 wt %, less than or equal to 5 wt %, less than or equal to 4 wt %, less than or equal to 2 wt %, less than or equal to 1.2 wt %, or less than or equal to 1 wt % versus the total weight of the sweetener. Combinations of the above-referenced ranges are also possible (e.g., greater than or equal to 0.5 wt % and less than or equal to 10 wt %). Other ranges are also possible. In an exemplary set of embodiments, sorbitol is present in the sweetener in an amount greater than or equal to 1.2 wt % and less than or equal to 5.4 wt %.

In some embodiments, sucrose is present in the sweetener in an amount greater than or equal to 0 wt %, greater than or equal to 1 wt %, greater than or equal to 2 wt %, greater than or equal to 5 wt %, greater than or equal to 10 wt %, greater than or equal to 15 wt %, or greater than or equal to 17.9 wt % versus the total weight of the sweetener. In some embodiments, sucrose is present in the sweetener in an amount less than or equal to 20 wt %, less than or equal to 17.9 wt %, less than or equal to 15 wt %, less than or equal to 10 wt %, less than or equal to 5 wt %, less than or equal to 2 wt %, or less than or equal to 1 wt % versus the total weight of the sweetener. Combinations of the above-referenced ranges are also possible (e.g., greater than or equal to 0 wt % and less than or equal to 20 wt %). Other ranges are also possible. In an exemplary set of embodiments, sucrose is present in the sweetener in an amount greater than or equal to 0 wt % and less than or equal to 17.9 wt %. In an exemplary set of embodiments, sucrose is present in the sweetener in an amount greater than 0 wt % and less than or equal to 17.9 wt %. In some embodiments, the sucrose is absent from the sweetener.

In an exemplary set of embodiments, the sweetener comprises fructose in an amount of greater than or equal to 26.9 wt % and less than or equal to 53.6 wt %, glucose in an amount of greater than or equal to 9 wt % and less than or equal to 30.6 wt %, and sorbitol in an amount of greater than or equal to 1.2 wt % and less than or equal to 5.4 wt %. According to some such embodiments, the sweetener further comprises sucrose in an amount of greater than 0 wt % and less than or equal to 17.9 wt %.

In some embodiments, the sweetener is characterized in having a desirable Brix. Brix as used herein is given its ordinary meaning in the art and generally refers to the grams of sucrose in 100 grams of solution. In some embodiments, the sweetener has a Brix of greater than or equal to 70, greater than or equal to 72, greater than or equal to 74, greater than or equal to 75, greater than or equal to 76, or greater than or equal 78. In some embodiments, the sweetener has a Brix of less than or equal to 80, less than or equal 78, less than or equal 76, less than or equal to 75, less than or equal 74, or less than or equal 72. Combinations of the above-referenced ranges are also possible (e.g., greater than or equal to 70 and less than or equal to 80).

In some embodiments, the sweetener has a glycemic index of less than or equal to 55, less than or equal to 50, less than or equal to 45, or less than or equal to 40. In some embodiments, the sweetener has a glycemic index of greater than or equal to 35, greater than or equal to 40, greater than or equal to 45, or greater than or equal to 50. Combinations of the foregoing ranges are possible (e.g., greater than or equal to 35 and less than or equal to 55). Other ranges are also possible. The glycemic index may be measured, in some embodiments, according to ISO 26642:2010.

In some embodiments, the sweetener has a number of calories of less than or equal to 20 kilocalories, less than or equal to 15 kilocalories, less than or equal to 10 kilocalories, or less than or equal to 5 kilocalories per 4 grams of sweetener. In some embodiments, the sweetener has a number of calories of greater than or equal to 2 kilocalories, greater than or equal to 5 kilocalories, greater than or equal to 10 kilocalories, or greater than or equal to 15 kilocalories per 4 grams of sweetener. Combinations of the above-referenced ranges are also possible (e.g., greater than or equal to 2 kilocalories and less than or equal to 20 kilocalories per 4 grams of sweetener). Other ranges are also possible. The number of calories may be measured, in some embodiments, using a bomb calorimeter according to methods known by those of ordinary skill in the art based upon the teachings of this specification.

In some embodiments, the additive comprises the sweetener and a diluent. The diluent may be any suitable diluent generally used in foods and/or beverages. In some embodiments, the diluent comprises water. However, in some embodiments, the additive comprises no additional components other than the sweetener.

In some embodiments, the additive comprises one or more fruit components. For example, in some embodiments, the sweetener is derived from, and/or comprises, one or more fruit components. In some embodiments, the one or more fruit components are derived from a fruit selected from the group consisting of pomes (e.g., apple, pear, quince, loquat, medlar, rowan), citrus (e.g., lemon, grapefruit, orange), gourds, berries and/or aggregate fruits (e.g., blueberry, strawberry, raspberry, cranberry, elderberry, blackberry, currant, banana, tomato, grape, watermelon, pumpkin, melons), and drupes (e.g., mango, peach, plum, cherry, apricot). In an exemplary set of embodiments, the fruit is apple.

In some embodiments, the one or more fruit components comprises peel/skin, flesh/pulp, pit, seed, sepal, pistil and/or pedicel.

In some embodiments, the one or more fruit components comprises a liquid. As used herein, a “liquid” is given its ordinary meaning. A liquid generally cannot maintain a defined shape and will flow during an observable time frame to fill the container in which it is put. Thus, the liquid may have any suitable viscosity that permits flow. In some embodiments, the liquid is an extract, a concentrate, a juice, a nectar, and/or a syrup.

In some embodiments, the liquid is a deionized liquid (e.g., a deionized juice concentrate).

In some embodiments, the additive is in powder or granular form. In some embodiments, the additive is in liquid form. In some embodiments, the additive comprises an aqueous solution comprising the sweetener. In some embodiments, the sweetener is water soluble.

Advantageously, the additives and/or sweeteners described herein may have a relatively long shelf life. For example, in some embodiments, the additive and/or sweetener has a shelf-life of greater than or equal to 1 year, greater than or equal to 2 years, greater than or equal to 3 years and/or less than or equal to 5 years, less than or equal to 8 years, or less than or equal to 10 years, at room temperature.

In some embodiments, the sweetener is substantially colorless and/or substantially odorless. For example, in some embodiments, the sweetener is a liquid and may be similar in appearance to liquid water. In some embodiments, the sweetener may have a yellow and/or brown hue.

Advantageously, in some embodiments, the sweetener further comprises one or more additional low glycemic, and/or low caloric, natural and/or artificial sweeteners. Non-limiting examples of suitable additional sweeteners include Stevia, aspartame, sorbitol, erythritol, cane sugar, monk fruit, and other natural and/or artificial sweeteners.

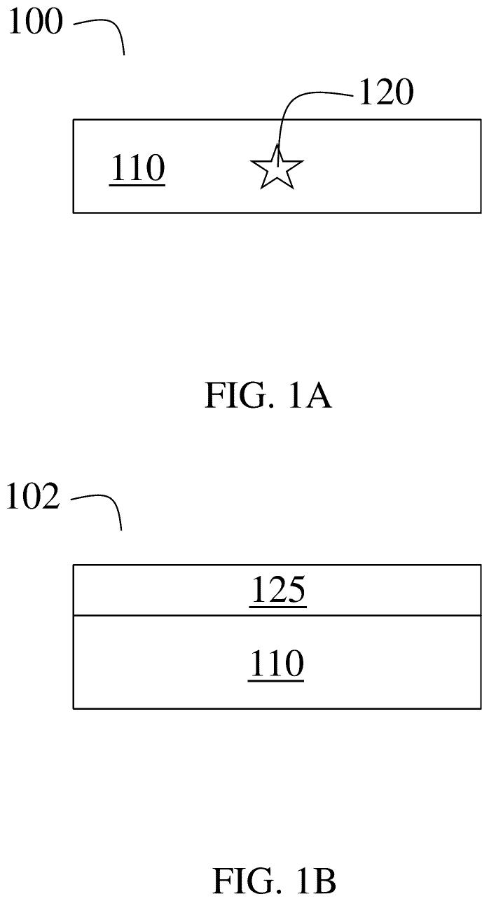

In some embodiments, edible consumer products are provided. In some embodiments, the edible consumer product is a food product. In some embodiments, the edible consumer product is a beverage. FIG. 1A is a schematic diagram showing an exemplary edible consumer product 100 comprising a food and/or beverage 110 and an additive 120. In some embodiments, additive 120 comprises a sweetener, as described elsewhere herein. An alternative example of an edible consumer product 102 is shown in FIG. 1B comprising a food and/or beverage 110 and a coating 125. In some embodiments, coating 125 comprises the additive (e.g., a sweetener). While FIG. 1B depicts coating 125 disposed directly on food and/or beverage 110, those of ordinary skill in the art would understand that one or more intervening layers and/or coatings may be present (e.g., each comprising or not comprising the additive). It would also be understood that FIGS. 1A and 1B are non-limiting examples and are generally included for illustrative purposes. Other arrangements, configurations, and combinations of food, beverages, and additive are also possible.

In some embodiments, the additive may be present in one or more components of an edible consumer product. For example, in some embodiments, an edible consumer product comprises two or more components (e.g., a baked layer and a filling; a baked layer and a coating; two or more liquid components; etc.) such that at least one of the two or more components comprises the additive. In some embodiments, each additive in each component of the edible consumer product is the same or different (e.g., comprising different amounts of sugars, present in different concentrations, derived from different fruits, etc.). Those of ordinary skill in the art would be capable of selecting suitable additives based upon the teachings of this specification for various edible consumer products.

In some embodiments, the edible consumer product is a food and comprises a coating and/or powder, the coating and/or powder comprising an additive as described herein.

In some embodiments, the edible consumer product is a beverage and comprises an additive as described herein.

In some embodiments, the edible consumer product (e.g., food, beverage) meets FDA standards for a “no sugar added” designation according to 21 CFR 101.60 (c).

In some embodiments, provided is a healthy sweetener including a composition comprising an apple component, in any one or more of a variety of forms, in combination with at least one sweetener component that lowers the glycemic index and calorie count of the apple component, while preferably increasing its sweetness. In various embodiments, the healthy sweetener is a low-glycemic, low-calorie (LGLC) healthy sweetener.

In some embodiments, the healthy sweetener is formed by blending or otherwise combining the apple component with at least one other low glycemic and/or low caloric sweetener, preferably that increases sweetness.

In an exemplary set of embodiments, the sweetener component can be or include one or more natural sweeteners and/or artificial sweeteners, such as Stevia, aspartame, sorbitol, erythritol, cane sugar, monk fruit, or similar known or hereafter developed low glycemic and/or low caloric sweeteners or compounds, while increasing sweetness.

In an exemplary set of embodiments, the apple component contains 75±5 Brix of sugar, has a glycemic index of not more than about 55 and preferably less than 50, and is stable at ambient room temperatures for up to about 3 years.

In an exemplary set of embodiments, the additive comprises one or more fruit components. According to some embodiments, the one or more fruit components is substantially colorless and odorless, or at least near colorless and odorless. In some embodiments, the one or more fruit components has a mild sweet taste. In an exemplary set of embodiments, the one or more fruit components has a mild sweet odor. In some embodiments, the fruit from which the one or more fruit components is derived is an apple. According to some such embodiments, the apple component is substantially colorless and odorless, or at least near colorless and odorless. In some embodiments, the apple component has a mild sweet taste. In an exemplary set of embodiments, the apple component has a mild sweet odor. In an exemplary set of embodiments, the apple component includes deionized apple juice concentrate which has increased stability. In an exemplary set of embodiments, the additive comprises one or more fruit components. In some such embodiments, the fruit from which the one or more fruit components is derived is an apple. According to some such embodiments, the apple component can have a calorie count of about 10 calories per ½ teaspoon (4 grams). In an exemplary set of embodiments, the sweetener component can lower glycemic index by about 10% or greater and calorie count by about 10% or greater and increase sweetness by about 10% or greater. In some embodiments, other degrees of lowering the glycemic index and/or the calorie count and/or increasing the sweetness may be realized by the healthy sweetener.

In an exemplary set of embodiments, the healthy sweetener can be reconstituted with water such that its use in products can bear the FDA designation “no sugar added.”

In an exemplary set of embodiments, the additive comprises one or more fruit components. In some such embodiments, the fruit from which the one or more fruit components is derived is an apple. According to some such embodiments, the apple component can comprise apple peel, apple flesh, or a combination thereof. In an exemplary set of embodiments, the apple component can take the form of a solid, such apple flesh and/or apple peel in dried or granular form, as examples. In an exemplary set of embodiments, the apple component can take the form of a liquid, such as an extract, concentrate, juice, nectar, or syrup comprising apple flesh and/or peel, as examples. In some embodiments, the apple component can take the form of or include apple nectar or concentrated apple juice.

In an exemplary set of embodiments, the additive comprises one or more fruit components. In some such embodiments, the fruit from which the one or more fruit components is derived is an apple. According to some such embodiments, the apple component can include apple in dried and/or liquid form. In an exemplary set of embodiments, the apple component can be a combination of an apple liquid with an apple in a solid or dried form, e.g., granular or powder.

In an exemplary set of embodiments, the additive comprises one or more fruit components. In some such embodiments, the fruit from which the one or more fruit components is derived is an apple. According to some such embodiments, the apple component in the solid form can be soluble, but in some embodiments the apple component in the solid form can be insoluble. In an exemplary set of embodiments, the apple component in the solid form can include an insoluble portion and a soluble portion. Other combinations of insoluble and/or soluble apple peel and/or flesh in liquid and/or dried form can be used to form the apple component.

It should be understood that the apple component is generally described as comprising apple, but that it may more broadly be a fruit component that comprises one or more other (non-apple) fruits as an alternative to or in combination with apple in dried and/or liquid form. In such embodiments, a healthy sweetener in accordance with aspects of the inventive concepts can include a fruit component and a sweetener component that lowers the glycemic index and calorie count of the fruit component while preferably increasing sweetness. In some embodiments, the additives and/or sweeteners described herein may be used in recipes in place of other sweeteners (e.g., conventional sweeteners such as sugars, honey, maple syrup, artificial sweeteners, natural sweeteners, etc.).

In an exemplary set of embodiments, the healthy sweetener can be added to or used as an ingredient in the preparation of a variety of types foods or beverages. In an exemplary set of embodiments, the healthy sweetener can be used as a dry or liquid condiment.

In an exemplary set of embodiments, the sweetener component increases the sweetness of the apple (or fruit) component. In some embodiments, the additive comprising the sweetener and/or the apple (or fruit) components, when added to a consumer product, can lower the glycemic index and/or the calorie count and/or increase the sweetness of the consumer product, e.g., when compared to the consumer product sweetened by conventional sweeteners.

In an exemplary set of embodiments, the healthy sweetener can be used as low glycemic, low calorie sweetener substitute in any food or beverage product in place of processed sugar, corn syrup, or other sweeteners. Such food products can include, but are not limited to, cereal, baked goods, sports bars, breakfast bars, granola, gummies and candies, yogurt, ice cream, mixes for baked goods, and so forth. Such beverages can include, but are not limited to, soft drinks, sodas, juices, teas, smoothies, vitamin supplement and/or probiotic drinks, waters, sports drinks, milks, and so forth. It should be understood that other foods and beverages are also possible, as this disclosure is not so limited. In some embodiments, the edible consumer product comprises at least one member selected from the group consisting of juice, soda, milk, tea, smoothie, water, sports drink, ketchup, mustard, mayonnaise, syrup, honey, jelly, peanut butter, butter, chocolate syrup, shortening, butter, margarine, oleo, grease, dip, yogurt, sour cream, oil, marshmallow, dough, batter, baked goods, chewing gum, bubble gum, butter, cheese, cream, cream cheese, mustard, yogurt, sour cream, curry, sauce, dessert toppings, whipped cream and toothpaste.

In some embodiments, the values and/or ranges of the above could be different. While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

It is appreciated that certain features of the invention, which are, for clarity, described in the context of separate embodiments, may also be provide in combination in a single embodiment. Conversely, various features of the invention which are, for brevity, described in the context of a single embodiment may also be provided separately or in any suitable sub-combination.

### EXAMPLES

The following examples are intended to illustrate certain embodiments described herein, including certain aspects of the present invention, but do not exemplify the full scope of the invention.

### Example 1

A sweetener comprising fructose in an amount of 26.9-53.6 wt %, glucose in an amount 9.0-30.6 wt %, sorbitol in an amount of 1.2-5.4 wt %, and sucrose in an amount of 0-17.9 wt % versus the total sweetener weight was produced. The sweetener had 75±5 Brix and a glycemic index of not more than 55.

### Example 2

The glycemic index (GI) of an apple-derived sweetener was determined using the protocol described in a standard ISO method (ISO 26642:2010 “Food products-Determination of the glycemic index and recommendation for food classification”). The sweetener tested in this Example corresponds to an additive as described elsewhere herein.

### Protocol

Ten subjects (e.g., males or non-pregnant females aged 18-75 years old and in good health) underwent treatments on separate days, with each subject performing up to 3 tests per week separated by at least one day. Subjects fasted overnight for 10 to 14 hours, whereafter the subjects had two blood samples taken 5 minutes apart for the fasting blood samples. The subject then consumed a test meal within 15 minutes. Further blood samples were obtained at 15, 30, 45, 60, 90, and 120 minutes after the start of the test meal. Subjects remained seated quietly during the two hours of the test.

### Test Meals

The test meals consisted of a portion of the sweetener (e.g., test food) or white bread containing 25 grams of available carbohydrates (defined as total carbohydrate minus dietary fiber/non digestible carbohydrates). The portion size of the test food was calculated based on the results of nutrition analysis and ingredients list associated with the samples. Each subject was given a choice of a beverage (water, coffee, or tea with 30 mL of 2% milk and a non-colie sweetener if desired) to consume with the test food. The beverage chosen was kept the same for all test meals. The control meal was tested two times by all subjects.

### BLOOD Samples

Blood samples (300 microliters each) we're collected into tubes containing heparin to prevent clotting and fluoride to inhibit glycolysis. Upon collection, samples were immediately centrifuged AT2000G for 5 minutes and refrigerated. Plasma glucose analysis, using a VITROS 350 analyzer (Ortho Clinical Diagnostics), took place within 5 days of collection.

### Data Analysis

Data were imported by middleware software instrument manager (Data Innovations) from the VITROS 350 analyzer into a spreadsheet. Incremental area under the curve (IAUC) values were calculated using the trapezoid rule, ignoring area beneath the baseline. For the purpose of IAUC calculation, fasting glucose was taken to be the mean of the first measurement of the glucose concentration at times-5 and 0 minutes. Glucose was measured in the 0 minute fasting sample two times and the data was used to determine the standard deviation (SD) of the analytical variation as follows:

$$SD = √ ( \frac{\sum {d}^{2}}{n} )$$

The GI was calculated by expressing each subject's glucose IAUC for the test food as a percentage of the same subjects mean response after reference meal and, if required, adjusting the GI to the glucose scale where glucose equals 100 and white bread equals 71. A second statistical analysis was done on the GI values after excluding those values greater than two standard deviations above the mean in which case excluded values were replaced by the mean of the remaining values in the error degrees of freedom in the ANOVA was reduced by the number of outliers excluded. After demonstrating significant heterogeneity, the differences between individual means were assessed using Tukey's test to control for multiple comparisons, with the criterion for significance being 2-tailed p<0.05. Means which differ by more than the least significant difference (LSD) differ significantly.

### Results

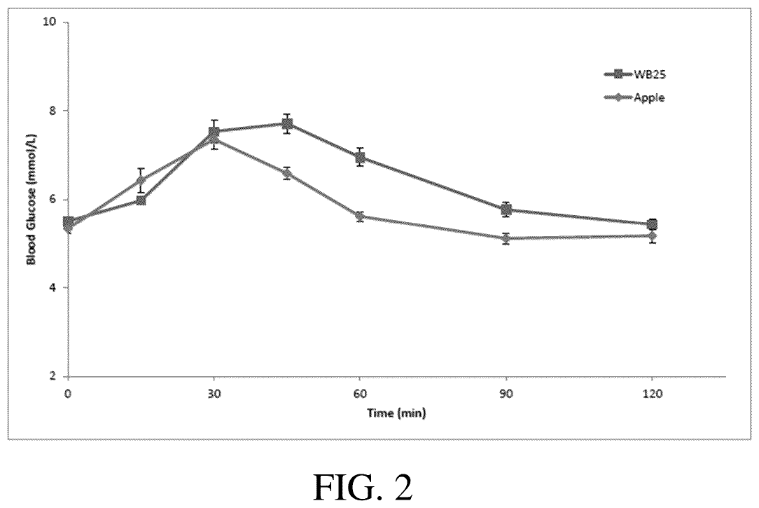

FIG. 2 shows the blood glucose level (mean+SEM) for subjects as a function of time after consuming the sweetener or the control meal (25 g of white bread, WB25, GI of 71). These data were analyzed to determine the GI of the sweetener, which is shown in Table 1.

TABLE 1
GI values for white bread control and the sweetener.

| | | IAUC | | GI |
|---|---|---|---|---|
| Test Meal | Abbreviation | (mmol*min/L | GI | category |
| White bread | WB25 | 115.5 ± 13.9 | 71 | High |
| control | | | | |
| Sweetener | Apple | 73.6 ± 7.4 | 49 ± 6 | Low |

Table 1 shows that the sweetener has a low glycemic index.

Additional exemplary additives and sweeteners are described in at least U.S. provisional patent application 63/539,559 filed Sep. 20, 2023 and entitled Healthy Sweetener, U.S. provisional patent application 63/535,550 filed Aug. 30, 2023 and entitled Healthy Sweetener, U.S. provisional patent application 63/454,906 filed Mar. 27, 2023 and entitled Healthy Sweetener, and U.S. provisional patent application 63/598,528 filed Nov. 13, 2023 and entitled Healthy Sweetener, each of which are incorporated herein by reference in their entirety for all purposes.

While several embodiments of the present disclosure have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize, or be able to ascertain using no more than routine experimentation, many equivalents to the specific embodiments of the disclosure described herein. It is, therefore, to be understood that the foregoing embodiments are presented by way of example only and that, within the scope of the appended claims and equivalents thereto, the disclosure may be practiced otherwise than as specifically described and claimed. The present disclosure is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When the word “about” is used herein in reference to a number, it should be understood that still another embodiment of the disclosure includes that number not modified by the presence of the word “about.”

It should also be understood that, unless clearly indicated to the contrary, in any methods claimed herein that include more than one step or act, the order of the steps or acts of the method is not necessarily limited to the order in which the steps or acts of the method are recited. In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A food and/or beverage additive, the additive comprising:
a sweetener comprising:
fructose present in an amount greater than or equal to 20 wt % and less than or equal to 60 wt % versus the total weight of the sweetener;
glucose present in an amount greater than or equal to 5 wt % and less than or equal to 35 wt % versus the total weight of the sweetener;
sorbitol present in an amount greater than or equal to 0.5 wt % and less than or equal to 10 wt % versus the total weight of the sweetener; and
sucrose present in an amount greater than or equal to 0 wt % and less than or equal to 20 wt % versus the total weight of the sweetener,
wherein the sweetener has one or more of the following properties:
i) a Brix of greater than or equal to 70 and less than or equal to 80;
ii) a glycemic index of less than or equal to 55 as measured according to ISO 26642:2010; and/or
iii) a number of calories of less than or equal to 20 kilocalories per 4 grams of sweetener as measured using a bomb calorimeter.

2. A food and/or beverage additive as in claim 1, wherein the additive comprises a diluent (e.g., water).

3. A food and/or beverage additive as in claim 1, wherein the additive further comprises one or more fruit components.

4. A food and/or beverage additive as in claim 3, wherein the one or more fruit components are derived from a fruit selected from the group consisting of pomes (e.g., apple, pear, quince, loquat, medlar, rowan), citrus (e.g., lemon, grapefruit, orange), gourds, berries and/or aggregate fruits (e.g., blueberry, strawberry, raspberry, cranberry, elderberry, blackberry, currant, banana, tomato, grape, watermelon, pumpkin, melons), and drupes (e.g., mango, peach, plum, cherry, apricot).

5. A food and/or beverage additive as in claim 4 wherein the fruit is an apple.

6. A food and/or beverage additive as in claim 3, wherein the one or more fruit components comprise peel/skin, flesh/pulp, pit, seed, sepal, pistil and/or pedicel.

7. A food and/or beverage additive as in claim 3, wherein the one or more fruit components comprise a liquid (e.g., an extract, a concentrate, a juice, a nectar, a syrup).

8. A food and/or beverage additive as in claim 1, wherein the additive is in powder or granular form.

9. A food and/or beverage additive as in claim 1, wherein the additive is in liquid form.

10. A food and/or beverage additive as in claim 1, wherein the additive comprises an aqueous solution comprising the sweetener.

11. A food and/or beverage additive as in claim 1, wherein the additive has a shelf-life of greater than or equal to 1 year, greater than or equal to 2 years, or greater than or equal to 3 years, at room temperature.

12. A food and/or beverage additive as in claim 1, wherein the sweetener is water soluble.

13. A food and/or beverage additive as in claim 1, wherein the sweetener is substantially colorless and/or substantially odorless.

14. A food and/or beverage additive as in claim 1, wherein the sweetener further comprises one or more additional low glycemic, and/or low caloric, natural and/or artificial sweeteners.

15. A food and/or beverage additive as in claim 1, further comprising Stevia, aspartame, erythritol, cane sugar, monk fruit, and/or other natural and/or artificial sweeteners.

16-30. (canceled)

31. An edible consumer product, the edible consumer product comprising:
a beverage; and
an additive comprising a sweetener, the sweetener comprising:
fructose present in an amount greater than or equal to 20 wt % and less than or equal to 60 wt % versus the total weight of the sweetener;
glucose present in an amount greater than or equal to 5 wt % and less than or equal to 35 wt % versus the total weight of the sweetener;
sorbitol present in an amount greater than or equal to 0.5 wt % and less than or equal to 10 wt % versus the total weight of the sweetener; and
sucrose present in an amount greater than or equal to 0 wt % and less than or equal to 20 wt % versus the total weight of the sweetener.

32. An edible consumer product as in claim 31, wherein the edible consumer product meets FDA standards for a “no sugar added” designation according to 21 CFR 101.60 (c).

33. A food and/or beverage additive as in claim 31, wherein the additive further comprises one or more fruit components.

34. A food and/or beverage additive as in claim 33, wherein the one or more fruit components are derived from a fruit selected from the group consisting of pomes (e.g., apple, pear, quince, loquat, medlar, rowan), citrus (e.g., lemon, grapefruit, orange), gourds, berries and/or aggregate fruits (e.g., blueberry, strawberry, raspberry, cranberry, elderberry, blackberry, currant, banana, tomato, grape, watermelon, pumpkin, melons), and drupes (e.g., mango, peach, plum, cherry, apricot).

35-45. (canceled)

46. A food and/or beverage additive, the additive comprising:
an apple-derived sweetener comprising fructose, glucose, sorbitol, and sucrose,
wherein the sweetener has a Brix of greater than or equal to 70 and less than or equal to 80 and a glycemic index of less than or equal to 55 as measured according to ISO 26642:2010.

47-61. (canceled)
